(19) United States
(12) Patent Application Publication
(10) Pub. No.: US 2008/0008819 A1
(43) Pub. Date: Jan. 10, 2008

(54) ANIMAL DRINK

(75) Inventor: Pietro Gaggiotti, Parna. (IT)

Correspondence Address: LATHROP & GAGE LC, 2345 GRAND AVENUE, SUITE 2800, KANSAS CITY, MO, 64108, US

(73) Assignee: Lightning Beverage U.S.A., LLC

(21) Appl. No.: 11/845,528

(22) Filed: Aug. 27, 2007

Related U.S. Application Data
(60) Provisional application No. 60/842,126, filed on Sep. 1, 2006.

(30) Foreign Application Priority Data
Jul. 4, 2006 (IT) BO2006A 000515

(51) Int. Cl. A23K 1/00

(52) U.S. Cl. 426/635; 426/655

(57) ABSTRACT

A drink for animals based on water, contains meat or meat extracts from cows, chickens or fish. This drink can also contain vegetables or vegetables extracts, such as carrots, celery or onion. In agreement with one possible varying productive the drink also contains vitamins (such as E vitamin), minerals, lactate calcium, casein calcium and/or proteins such as soy proteins.

### RELATED APPLICATIONS

This application claims the benefit of U.S. Provisional Patent Application No. 60/842,126 filed Sep. 1, 2006 under the same title and inventorship.

### BACKGROUND OF THE INVENTION

1. Field of the Invention

The present invention relates generally to the field of animal foods.

2. Description of the Related Art

Domestic animals such as dogs and cats feed on cooked and raw meat, cut or minced in small pieces, with mixed vegetables, milk, rice, and pasta. Ideally, the food given to dogs guarantees a complete and balanced diet. In particular, beyond to the solid foods, on which the greater part of the nutrition depends, it is essential that the dog also receive a sufficient amount of water daily. Driving this need is that water constitutes more than half of the composition of any animal's tissues, especially in dogs.

An important problem with the conventional practice of providing the animal solid food and water separately, is that the proper hydration, especially with dogs, is not guaranteed. Thus, hydration is dependent on (i) the owner providing the proper amounts, and (ii) the dog electing to consume the proper quantity. And many dogs are reluctant to consume substantially pure water because of, i.e., lack of taste. Oftentimes consumption deficiencies lead to unhealthy dehydration.

Artisans in the past have attempted to use flavoring to compel consumption. For example, water has been flavored water with a meat, fish or vegetable taste to tempt the dog to drink a sufficient amount. But these water flavorings don't provide the nutrition an animal needs. Especially in the growing phases of dogs.

Therefore, there is a need in the art for a product that meets the nutritious needs of the animal while at the same time better maintains hydration.

### SUMMARY OF THE INVENTION

The present invention overcomes these shortcomings in the prior art by providing a drinkable animal food product comprising a water base and foodstuffs. The foodstuffs may include one of a meat and a meat extract, as well as numerous other nutritious items.

Also disclosed is a method of marketing the animal food product comprising providing a nutritious combination of foodstuffs; including said foodstuffs in a water base for the purpose of making said food product drinkable; and aseptically sealing said food product in a container for the purpose of marketing said food product to consumers.

### DETAILED DESCRIPTION OF THE INVENTION

The present invention provides an animal drink and an associated method of presenting that drink to consumers. The drink is water-based and contains meat or meat extracts from cows, chickens or fish. This drink can also contain vegetables or vegetables extracts, such as carrots, celery or onion. In one embodiment, the drink also contains vitamins (such as E vitamin), minerals, lactate calcium, casein calcium and/or proteins such as soy proteins. The drink can substitute a nutritious meal and also giving the amount of water necessary in the growing phase. The combinations of ingredients favor the digestive system of the animal and can be consumed by old dogs or post-operated dogs.

Another aspect is that the product is easily and inexpensively produced.

These advantages are realized by regulating ingredients according to numerous embodiments, several of which are disclosed herein. The examples provided herein, however, should be considered illustrative, but not restrictive of the scope of the present invention.

Generally, the embodiments of the drink for animals are water based and include foodstuffs. In one embodiment, the product includes all natural human grade ingredients having no preservatives or artificial colors. Further, all ingredients are “food grade” certified, meaning that they have been recognized as suitable for human consumption. These foodstuffs may include meat or meat extracts of chicken or cow, preferably calf meat. The product, in embodiments, will have a final base concentration in water of 2.5% to 3.2% and a Ph of about 5.5.

In a first embodiment, the drink can contain also vegetables such as carrots, celery or onion or vegetables extracts. More specifically, a first embodiment for a dog drink includes a combination of ingredients comprising:
Water comprises approximately between 70%-80% of the total weight of the drink (preferably 74%);
Chicken meat or chicken meat extracts comprise approximately between 3%-12% of the total weight of the drink (preferably 7%);
Beef or beef extracts comprise approximately between 3%-12% of the total weight of the drink (preferably 7%);
Carrots comprise approximately between 1%-8% of the total weight of the drink (preferably 4%);
Celery comprises approximately between 1%-8% of the total weight of the drink (preferably 4%);
Onion comprises approximately between 1%-8% of the total weight of the drink (preferably 4%).

In a second embodiment, the drink can also contain fish or fish extracts. In this recipe the percentage of fish or fish extracts is approximately between 3%-20% of the total weight of the drink with the same percentages of water and vegetables.

In a third embodiment, the drink for animals based on water and meat or meat extracts can also contain vitamins or minerals and in particular E vitamin and/or calcium. In this recipe the optimal percentage of E vitamin is approximately between 5%-10% of the total weight of the drink while the optimal percentage of calcium is approximately between 4%-8% of the total weight of the drink.

In a fourth embodiment, the drink for animals based on water and meat or meat extracts can contain, beyond vitamins and minerals, also proteins, and in particular, soy proteins. In this recipe the optimal percentage of soy proteins is approximately between 3%-15% of the total weight of the drink. More specifically, the fourth embodiment, includes:
Water comprises approximately between 70%-80% of the total weight of the drink (preferably 74%);
Chicken meat or chicken meat extracts comprise approximately between 3%-12% of the total weight of the drink (preferably 7%);
Beef or beef extracts comprise approximately between 3%-12% of the total weight of the drink (preferably 7%);
Carrots comprise approximately between 1%-8% of the total weight of the drink (preferably 4%);
Celery comprises approximately between 1%-8% of the total weight of the drink (preferably 4%);
Onion comprises approximately between 1%-8% of the total weight of the drink (preferably 4%);
E vitamin comprises approximately between 5%-10% of the total weight of the drink;
Calcium comprises approximately between 4%-8% of the total weight of the drink;
Proteins comprise approximately between 3%-15% of the total weight of the drink.

The proteins added are preferably soy proteins while calcium can be lactated calcium or casein calcium.

In a fifth embodiment, the drink comprises:
Water, preferably demineralised, comprises approximately comprised between 97%-98% of the total weight of the drink;
Foodstuffs comprise approximately between 2%-3% of the total weight of the drink.

More specifically, the foodstuffs included in the fifth embodiment may include:
Natural extracts comprise approximately between 17%-22% of the total weight of the foodstuffs ingredients;
Flavors comprise approximately between 17%-22% of the total weight of the foodstuffs ingredients;
Sugar comprises approximately between 14.5%-18.5% of the total weight of the foodstuffs ingredients;
Salt comprises approximately between 14.5%-18.5% of the total weight of the foodstuffs ingredients;
Chicken proteins comprise approximately between 4.5%-5.5% of the total weight of the foodstuffs ingredients;
Chicken fat comprises approximately between 3.5%-4.6% of the total weight of the foodstuffs ingredients;
Dehydrated vegetables (powder) comprise approximately between 0.5%-1% of the total weight of the foodstuffs ingredients;
Minerals comprise approximately between 3.5%-26.5% of the total weight of the foodstuffs ingredients;
Vegetable proteins comprise approximately between 19%-20% of the total weight of the foodstuffs ingredients;
Vitamins comprise approximately between 4%-5% of the total weight of the foodstuffs ingredients.

Natural extracts included comprise approximately between 13%-17% of yeast extracts and between 3.5%-5% of beef meat.

Flavors are preferably added as following:
Approximately 9%-11% roast-beef flavor;
Approximately 6%-7.5% roast meat flavor;
Approximately 3%-4% meat flavor.

Sugars included in the percentage above are approximately between 14%-17.5% of lactose and between 0.5%-1% of saccharose.

Dehydrated vegetables (powder), preferably carrots, included in the percentage above comprise approximately between 0.5%-1%.

Minerals, preferably casein calcium, comprise, comprise approximately between 4%-26.5%.

Vitamins, preferably vitamin E, comprise approximately 0%-5%.

The percentages of the ingredients of the fifth recipe can be changed allowing to fit the growing phases of the dog. Below, embodiments have been illustrated for young, adult, and old dogs.

A more specific embodiment optimized for consumption by young dogs includes:
Water, preferably demineralised, comprises approximately 97.3% of the total weight of the drink;
Foodstuffs comprise approximately 2.7% of the total weight of the drink.

More specifically, the foodstuffs ingredients for the young dog embodiment include the following:
Natural extracts comprise approximately 17.2% of the total weight of the foodstuffs ingredients;
Flavors comprise approximately 17.9% of the total weight of the foodstuffs ingredients;
Sugar comprises approximately 14.9% of the total weight of the foodstuffs ingredients;
Salt comprises approximately 14.9% of the total weight of the foodstuffs ingredients;
Chicken proteins comprise approximately 4.5% of the total weight of the foodstuffs ingredients;
Chicken fat comprises approximately 3.7% of the total weight of the foodstuffs ingredients;
Dehydrated vegetables (powder) comprise approximately 0.7% of the total weight of the foodstuffs ingredients;
Minerals comprise approximately 26.1% of the total weight of the foodstuffs ingredients.

The young dog embodiment above may comprise natural extracts included which comprise approximately 13.4% of yeast extracts and 3.7% of beef meat.

The flavors included in the young dog embodiment may comprise:
Approximately 9% roast-beef flavor;
Approximately 6% roast meat flavor;
Approximately 3% meat flavor.

Sugars included in the young dog embodiment include percentages of approximately 14.2% of lactose and 0.7% of saccharose.

The dehydrated vegetables included in the young dog embodiment are preferably introduced in powder form, and preferably comprise carrots in a percentage of approximately 0.7%.

The minerals included in the young dog embodiment, preferably casein calcium, are included in percentages of approximately 26.1%.

The disclosed invention also contemplates a drink for adult dogs. The adult dog embodiment meets the following specifications:
Water, preferably demineralised, comprises approximately 97.4% of the total weight of the drink;
Foodstuffs comprising approximately 2.6% of the total weight of the drink.

In particular, foodstuffs ingredients as following:
Natural extracts comprise approximately 17.8% of the total weight of the foodstuffs ingredients;
Flavors comprise approximately 18.6% of the total weight of the foodstuffs ingredients;
Sugar comprises approximately 15.5% of the total weight of the foodstuffs ingredients;
Salt comprises approximately 15.5% of the total weight of the foodstuffs ingredients;
Chicken proteins comprise approximately 4.7% of the total weight of the foodstuffs ingredients;
Chicken fat comprises approximately 3.9% of the total weight of the foodstuffs ingredients;
Dehydrated vegetables (powder) comprise approximately 0.8% of the total weight of the foodstuffs ingredients;
Minerals comprise approximately 3.9% of the total weight of the foodstuffs ingredients; and
Vegetable proteins comprise approximately 19.4% of the total weight of the foodstuffs ingredients.

Natural extracts included comprise approximately 14% of yeast extracts and 3.9% of beef meat.

Flavor are preferably added as following:
Approximately 9.3% roast-beef flavor;
Approximately 6.2% roast meat flavor;
Approximately 3.1% meat flavor.

Sugars included comprise approximately 14.7% of lactose and 0.8% of saccharose.

Dehydrated vegetables (powder), preferably carrots, comprise approximately 0.8%.

Minerals, preferably casein calcium, comprise approximately 3.9%.

An embodiment optimally concocted for an older dog comprises water, preferably demineralised, comprises approximately 97.8% of the total weight of the drink and foodstuffs comprise approximately 2.2% of the total weight of the drink.

More specifically, the foodstuff ingredients for the older dog drink comprise:
Natural extracts comprise approximately 21.1% of the total weight of the foodstuffs ingredients;
Flavors comprise approximately 22% of the total weight of the foodstuffs ingredients;
Sugar comprises approximately 18.3% of the total weight of the foodstuffs ingredients;
Salt comprises approximately 18.3% of the total weight of the foodstuffs ingredients;
Chicken proteins comprise approximately 5.5% of the total weight of the foodstuffs ingredients;
Chicken fat comprises approximately 4.6% of the total weight of the foodstuffs ingredients;
Dehydrated vegetables (powder) comprise approximately 0.9% of the total weight of the foodstuffs ingredients;
Minerals comprise approximately 4.6% of the total weight of the foodstuffs ingredients; and
Vitamins comprise approximately 4.6% of the total weight of the foodstuffs ingredients.

Natural extracts included in the older dog embodiment comprise approximately 16.5% of yeast extracts and 4.6% of beef meat. The flavors included are preferably added as follows:
Approximately 11% roast-beef flavor;
Approximately 7.3% roast meat flavor;
Approximately 3.7% meat flavor.

Also in the older dog embodiment, the sugars included comprise approximately 17.4% of lactose and 0.9% of saccharose. Further, dehydrated vegetables (powder), preferably carrots, comprise approximately 0.9%. Additionally, minerals, preferably casein calcium, comprise approximately 4.6%. The vitamins included, preferably vitamin E, comprise approximately 4.6%.

Alternatively, additional embodiments for young, adult, and older dogs are provided. These embodiments all include the same water to foodstuff ratios/percentages as in each of the original young, adult, and older dog embodiments. But the foodstuff compositions are different. In the alternative the foodstuffs optimized for consumption by young dogs include the following:
Natural extracts comprise approximately 17.0% of the total weight of the foodstuffs ingredients;
Flavors comprise approximately 17.8% of the total weight of the foodstuffs ingredients;
Sugar comprises approximately 14.8% of the total weight of the foodstuffs ingredients;
Salt comprises approximately 14.8% of the total weight of the foodstuffs ingredients;
Chicken proteins comprise approximately 4.4% of the total weight of the foodstuffs ingredients;
Chicken fat comprises approximately 3.7% of the total weight of the foodstuffs ingredients;
Dehydrated vegetables (powder) comprise approximately 0.7% of the total weight of the foodstuffs ingredients; and
Minerals comprise approximately 25.9% of the total weight of the foodstuffs ingredients.

The young dog alternative embodiment comprises natural extracts included which comprise approximately 13.3% of yeast extracts and 3.7% of beef meat.

The flavors included in the young dog alternative embodiment comprise:
Approximately 8.9% roast-beef flavor;
Approximately 5.9% roast meat flavor;
Approximately 3% meat flavor.

Sugars included in the young dog embodiment include percentages of approximately 14.1% of lactose and 0.7% of saccharose.

The dehydrated vegetables included in the young dog embodiment are preferably introduced in powder form, and preferably comprise carrots in a percentage of approximately 0.7%.

The minerals included in the young dog embodiment, preferably casein calcium, are included in percentages of approximately 25.9%.

The foodstuff breakdown for the alternative embodiment for the adult dog embodiment meets the following specifications:
Natural extracts comprise approximately 17.7% of the total weight of the foodstuffs ingredients;
Flavors comprise approximately 18.5% of the total weight of the foodstuffs ingredients;
Sugar comprises approximately 15.4% of the total weight of the foodstuffs ingredients;
Salt comprises approximately 15.4% of the total weight of the foodstuffs ingredients;
Chicken proteins comprise approximately 4.6% of the total weight of the foodstuffs ingredients;
Chicken fat comprises approximately 3.8% of the total weight of the foodstuffs ingredients;
Dehydrated vegetables (powder) comprise approximately 0.8% of the total weight of the foodstuffs ingredients;
Minerals comprise approximately 3.8% of the total weight of the foodstuffs ingredients; and
Vegetable proteins comprise approximately 19.2% of the total weight of the foodstuffs ingredients.

Natural extracts included comprise approximately 13.8% of yeast extracts and 3.8% of beef meat.

Flavor are preferably added as following:
Approximately 9.2% roast-beef flavor;
Approximately 6.2% roast meat flavor;
Approximately 3.1% meat flavor.

Sugars included comprise approximately 14.6% of lactose and 0.8% of saccharose.

Dehydrated vegetables (powder), preferably carrots, comprise approximately 0.8%.

Minerals, preferably casein calcium, comprise approximately 3.8%.

An alternative embodiment for an older dog has foodstuff ingredients comprising:
Natural extracts comprise approximately 20.9% of the total weight of the foodstuffs ingredients;
Flavors comprise approximately 21.8% of the total weight of the foodstuffs ingredients;
Sugar comprises approximately 18.2% of the total weight of the foodstuffs ingredients;
Salt comprises approximately 18.2% of the total weight of the foodstuffs ingredients;
Chicken proteins comprise approximately 5.5% of the total weight of the foodstuffs ingredients;
Chicken fat comprises approximately 4.5% of the total weight of the foodstuffs ingredients;
Dehydrated vegetables (powder) comprise approximately 0.9% of the total weight of the foodstuffs ingredients;
Minerals comprise approximately 4.5% of the total weight of the foodstuffs ingredients; and
Vitamins comprise approximately 4.5% of the total weight of the foodstuffs ingredients.

Natural extracts included in the older dog embodiment comprise approximately 16.4% of yeast extracts and 4.5% of beef meat. The flavors included are preferably added as follows:
Approximately 10.9% roast-beef flavor;
Approximately 7.3% roast meat flavor;
Approximately 3.6% meat flavor.

Also in the older dog embodiment, the sugars included comprise approximately 17.3% of lactose and 0.9% of saccharose. Further, dehydrated vegetables (powder), preferably carrots, comprise approximately 0.9%. Additionally, minerals, preferably casein calcium, comprise approximately 4.5%. The vitamins included, preferably vitamin E, comprise approximately 4.5%.

Use of a drink produced to according to the above noted ingredients has many advantages. First of all, selection of a drink tailored to the age of the animal will provide the necessary food and hydration at any stage of life. This provides the needed nutrition for proper growth and/or health. Second, the drink is easily digestible and can be consumed by old dogs or post operated dogs. More, the good taste of the drink allows an optimal hydration of the dog. As known, it is important for old dogs, post-operated dogs, and others to drink large quantities of liquids to maintain adequate hydration. This contributes to the brightness of the animal's coat. The owner consumer also has the benefit of substituting the easily administered drink with minimal effort. Because of this a quick and complete meal, including meat or fish, and vegetables, is easily fed to the animal while at the same time greatly enhancing health in terms of nutrition and hydration of the animal.

Other aspects of the product relate to the way in which it is manufactured and then presented to consumers. The selected drink is created including a desired combination of water, foodstuffs, and any other desired ingredients. The water undergoes osmosis filtration before being introduced. The solution is then subjected to an ultra heat treatment (UHT) including aseptic packaging processes executed in a sterile environment. These processes will enable the product to be included in a sealed container and presented to consumers, and ultimately consumed by an animal without the requirement of refrigeration (or some other spoilage prevention technique). These processes also enable lengthy storage (for at least 18 months) without the use of preservatives or other additives which might negatively affect taste and the health of the consuming animal.

The aseptic packaging processes used herein, including a combination of UHT, sterile packaging, and sterile filling, are known methods for packaging liquid products for human consumption, e.g., milk, juices, and teas. These conventional processes involve heating the liquid to partially sterilize the product, and then filling and packaging it all in a sterile environment. The preferred device for executing the UHT processes are referred to as UHT pasteurizing units.

With respect to the animal drink disclosed herein, a tube in tube heat exchanger is used to accomplish the temperature elevation. A heating medium, e.g., steam, is used to cause adequate heat to be absorbed by the animal drink product to a temperature adequate for sterilization. Other equipment, e.g., shell and tube, plate, or other heat exchanger devices could be used as well and still fall within the scope of the present invention.

In one embodiment, the drink is heated to above 135° Celsius for about 30 seconds to substantially sterilize the product. Alternatively, however, the product could be heated at higher temperatures for shorter time periods (e.g., about 145° Celsius for at least about 20 seconds), or at temperatures slightly lower than 135° Celsius for longer time periods. One skilled in the art will recognize that time and temperature can be manipulated to ensure substantial sterility. Alternatively, known flash sterilization techniques could be used.

In the preferred embodiment the drink, after undergoing sterilization in the heat exchanger, is directed to a sterile tank to serve as a buffer prior to filling. There, the drink is held and cooled until it reaches a desired temperature.

Once cooled (if any cooling is necessary) the drink product, which now has a final base concentration in water of 2.5% to 3.2%, is directed into some form of sealed, sterile aseptic packaging. Prewashed plastic bottles and caps have been used in the preferred embodiment. In operation, these bottles are aseptically filled and capped in a known manner. More specifically, multi-layer barrier 0.5 liter plastic bottles having 38 mm mouth size are used in some embodiments. Further, in some embodiments a sterile shrink-wrap sleeve label is included which includes indicia which indicates the product is intended for consumption by pets. Although plastic bottles are used in the present embodiment, the scope of this invention should not be limited to any particular packaging embodiment. For example, canning, sealed cartons, or other packaging techniques could be used instead and still fall within the parameters of the invention.

Once packaged in this manner, the product will have a shelf life of about 18 months without the use of any preservatives, or refrigeration. Because the it is able to be marketed as a pet drink without refrigeration or any other type of costly maintenance, the product is uniquely attractive to pet product retailers. Pet products are not normally located in refrigerated locations in stores. Thus, the aseptic packaging enables the pet drink to be included in with the other pet products on the shelves in a store, enhancing consumer exposure. It also reduces energy costs which would otherwise be consumed by the refrigeration units at the facility.

As can be seen, the present invention and its equivalents are well-adapted to provide a new and useful animal drink and method of packaging and marketing the product. Many different arrangements of the various components depicted, as well as components not shown, are possible without departing from the spirit and scope of the present invention.

The present invention has been described in relation to particular embodiments, which are intended in all respects to be illustrative rather than restrictive. Alternative embodiments will become apparent to those skilled in the art that do not depart from its scope. Many alternative embodiments exist but are not included because of the nature of this invention. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out order described.

The invention claimed is:

1. A drinkable animal food product comprising:
a water base; and
one of a meat and a meat extract.

2. The food product of claim 1 wherein said one of a meat and a meat extract is one of a chicken meat and a chicken meat extracts.

3. The food product of claim 1 wherein said one of a meat and a meat extract is one of beef or beef extracts.

4. The food product of claim 1 wherein said food product includes vegetables or vegetables extracts.

5. The food product of claim 1 wherein said food product includes carrots or carrots extracts.

6. The food product of claim 1 wherein said food product includes celery or celery extracts.

7. The food product of claim 1 wherein said food product includes onion or onion extracts.

8. The food product of claim 1 wherein said food product is approximately 70%-80% water by weight, and approximately 12%-35% one of chicken and chicken extracts by weight, approximately 3%-12% one of cow and cow extracts by weight, approximately 1%-8% one of carrots and carrots extracts by weight, and approximately 1%-8% one of celery and celery extracts by weight, and approximately 1%-8% one of onions and onion extracts in percentage of the total weight of the drink.

9. The food product of claim 1 wherein said food product includes fish or fish extracts.

10. The food product of claim 1 wherein said food product includes a vitamin.

11. The food product of claim 10 wherein said vitamin is vitamin E.

12. The food product of claim 1 wherein said food product includes minerals.

13. The food product of claim 1 wherein said food product includes calcium.

14. The food product of claim 1 wherein said food product includes proteins.

15. The food product of claim 14 wherein said proteins are soy proteins.

16. The food product of claim 1 wherein said food product includes yeast.

17. The food product of claim 1 wherein said food product includes sugars.

18. The food product of claim 1 wherein said food product includes vitamin E.

19. The food product of claim 1 wherein said water base comprises demineralised water.

20. A method of marketing an animal food product comprising:
providing a nutritious combination of foodstuffs;
including said foodstuffs in a water base for the purpose of making said food product drinkable;
aseptically sealing said food product in a container; and
delivering said food product to an entity for the purpose of marketing said food product to consumers.
